(19) United States
(12) Patent Application Publication
(10) Pub. No.: US 2014/0136606 A1
(43) Pub. Date: May 15, 2014

(54) CONSUMER AND BRAND OWNER DATA MANAGEMENT

(71) Applicant: Nfluence Media, Inc., Seattle, WA (US)

(72) Inventor: Brian Roundtree, Seattle, WA (US)

(73) Assignee: NFLUENCE MEDIA, INC., Seattle, WA (US)

(21) Appl. No.: 14/078,515

(22) Filed: Nov. 12, 2013

Related U.S. Application Data
(60) Provisional application No. 61/724,863, filed on Nov. 9, 2012.

(51) Int. Cl. H04L 29/08

(52) U.S. Cl. CPC H04L 67/306
USPC 709/203

(57) ABSTRACT

The disclosed tools include enhanced and flexible login and profile management tools as well as brand owner communication tools that provide more flexibility in regards to information sharing that benefit both users and brand owners and ease the integration of user information into brand owner databases.

### RELATED APPLICATIONS

This application claims benefit of and priority to U.S. Provisional Patent Application No. 61/724,863 filed Nov. 9, 2012, which is herein incorporated by reference in its entirety.

The following previously filed applications are herein incorporated by reference:
U.S. Provisional Patent Application No. 61/493,965;
U.S. Provisional Patent Application No. 61/533,049;
U.S. Provisional Patent Application No. 61/506,601;
U.S. Provisional Patent Application No. 61/567,594;
U.S. Provisional Patent Application No. 61/597,136;
U.S. Provisional Patent Application No. 61/603,216;
U.S. Provisional Patent Application No. 61/683,678;
U.S. Provisional Patent Application No. 61/724,863;
U.S. patent application Ser. No. 13/490,444, entitled “CONSUMER DRIVEN ADVERTISING SYSTEM”;
U.S. patent application Ser. No. 13/490,449, entitled “SYSTEM AND METHOD FOR DELIVERING ADS TO PERSONAS BASED ON DETERMINED USER CHARACTERISTICS”;
U.S. patent application Ser. No. 13/490,447, entitled “METHOD AND APPARATUS FOR DISPLAYING ADS DIRECTED TO PERSONAS HAVING ASSOCIATED CHARACTERISTICS”; and
International Patent Application No. PCT/US12/41178, entitled “CONSUMER DRIVEN ADVERTISING SYSTEM”.

The technology described in these applications as well as the current application are interoperable.

### APPENDICES

Appendix A has a description of technologies described in the incorporated applications.

### BACKGROUND

Currently, consumer users of email, e-commerce sites and other services provided by brand owners lack tools to efficiently and conveniently manage their account information across multiple brand owners. Specifically, users lack an ability to easily access said accounts and to meaningfully manipulate information in said accounts, in order to facilitate better delivery of meaningful and personalized content via their choice of brands.

What is specifically needed are enhanced and flexible login and profile management tools as well as brand owner communication tools that provide more flexibility in regards to information sharing that benefit both users and brand owners and ease the integration of user information into brand owner databases.

### BRIEF DESCRIPTION OF THE DRAWINGS

FIG. 1 illustrates an exemplary embodiment of identity mapping;

FIG. 2 illustrates a system whereby a user can verify her identity, authorize and receive personalized ads in accordance with an embodiment of the disclosed technology;

FIG. 3 illustrates another system whereby a user can verify her identity, authorize and receive personalized ads in accordance with an embodiment of the disclosed technology;

FIG. 4 illustrates an exemplary interest graph;

FIG. 5 illustrates one method of allowing a user to sort a number of brands to define likely demographic characteristics for a persona in accordance with an embodiment of the disclosed technology;

FIG. 6 illustrates one method by which likely demographic characteristics for a persona can be determined based on brand sorting by a user in accordance with an embodiment of the disclosed technology;

FIG. 7 illustrates how a selected persona defines a number of likely demographic characteristics that can be selected by advertisers to determine a target audience for advertisements in accordance with an embodiment of the disclosed technology;

FIG. 8 illustrates one representative method of determining a target audience from the likely demographic characteristics of a number of personas in accordance with an embodiment of the disclosed technology;

FIG. 9 illustrates one embodiment of a system for delivering advertisements to a user's computing device in accordance with the disclosed technology;

FIG. 10 illustrates further detail of a system for selecting and delivering advertisements to a user's computing device in accordance with an embodiment of the disclosed technology;

FIG. 11 illustrates one embodiment of a representative user interface screen displaying a persona's email program;

FIG. 12 further illustrates one embodiment of a representative user interface screen displaying a persona's email program;

FIG. 13 illustrates a block diagram of a user's computing device in accordance with an embodiment of the disclosed technology; and

FIG. 14 illustrates one embodiment of a networked computing system used in implementing the disclosed technology.

### DETAILED DESCRIPTION

### Profiles and Interest Graphs Primer

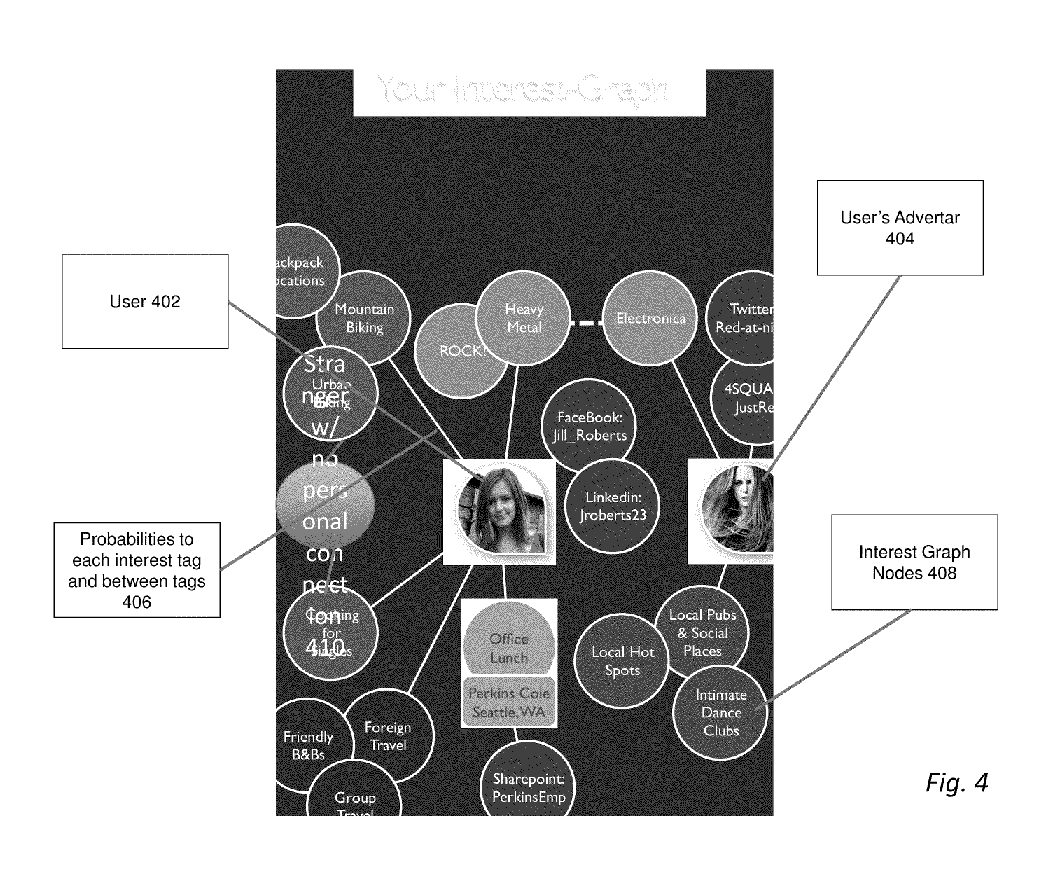

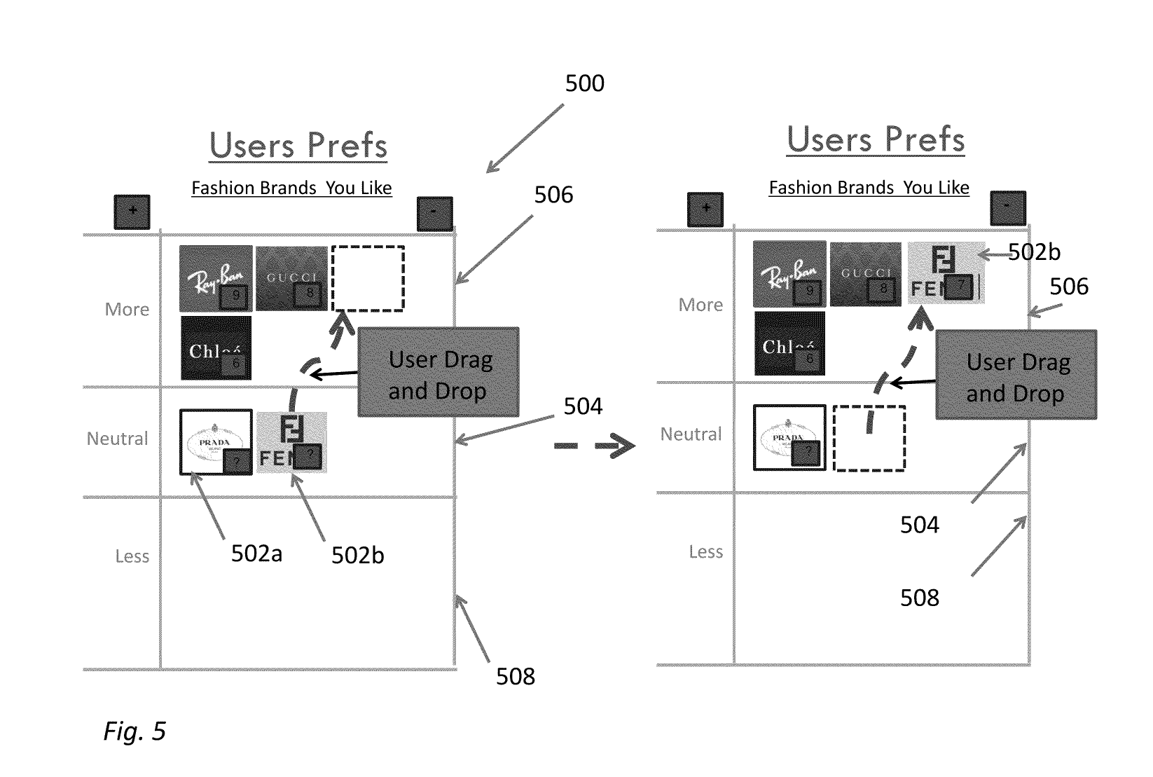

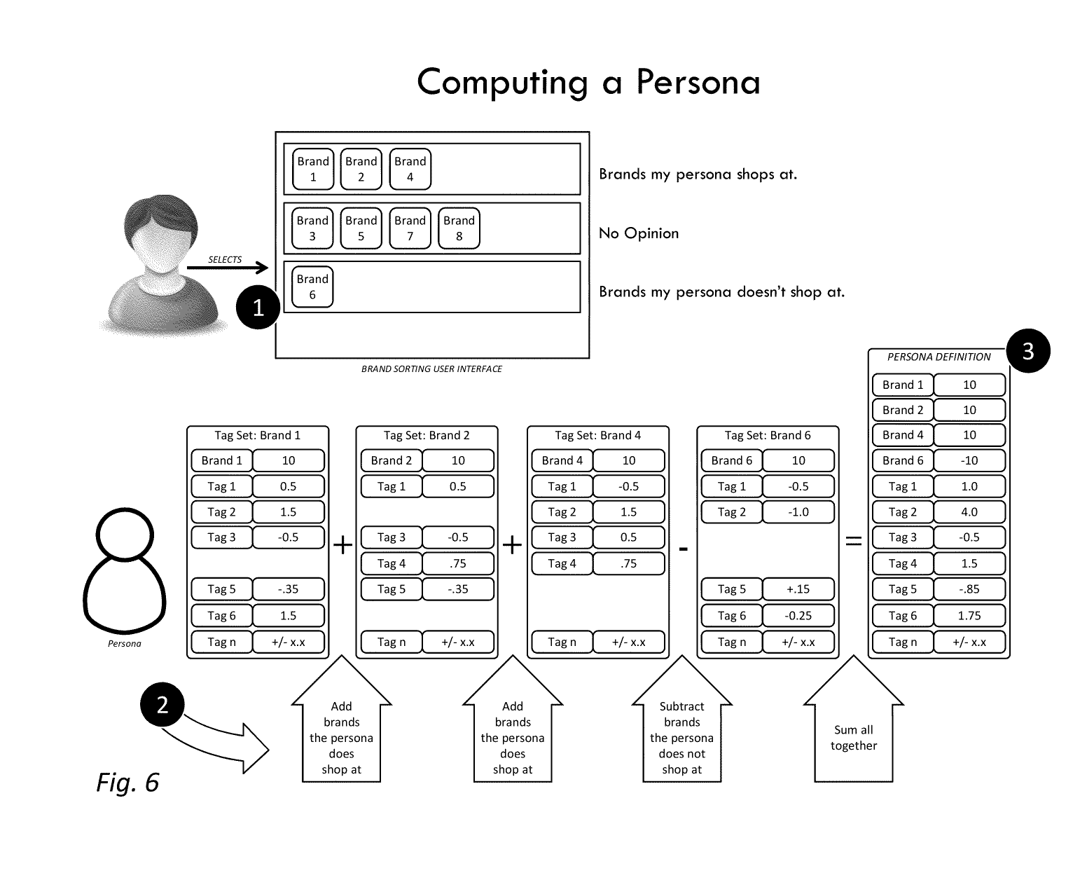

As discussed in previous patent applications, advertars and profiles of a user may reflect demographics/characteristics and associated probabilities of a user having said demographics/characteristics among other information. For example, FIG. 4 illustrates one embodiment of an interest graph reflecting such. As such, interest graphs may be a part of a profile. As the user sorts brands & swotes and inputs other information, interest graphs may created or supplemented with this data such as illustrated in FIGS. 5 and 6.

As opposed to a social graph (which may also be included or may contribute to a profile) an interest graph focuses on shared interests regardless of personal connections while a social graph focuses on connections based on personal connections. (In some embodiments, profiles may incorporate social graphs as well or just social graphs alone).

In one embodiment, an interest graph refers to the specific and varied interests that form one's personal identity, and the attempt to connect people based on those interests. Individually, this may mean different things. One person is interested in—be it jogging, celebrity gossip, or animal rights—that make up likes and dislikes, and what has more meaning to them over someone else. On a broader scale, it's the way those interests form unspoken relationships with others who share them, and expand to create a network of like-minded people.

While the social graph consists of who a user knows, the interest graph consists of what they like, what moves them, and the facets of their personality that, in part, make up who they are. These interests can be represented in an interest graph by an interest graph node 408 and the probabilities of each interest and between interest nodes 406 may also be incorporated into interest graphs. These connections can be much stronger, and much more telling, than simply who they are friends or acquaintances with. For example, two people being linked together because they knew each other in elementary school or work at the same job doesn't necessarily indicate anything about them beyond their connection to each other. And for the people involved, it doesn't always foster a very strong or lasting connection. As such, an interest graph may offer more insight into each person's personal tastes, preferences and behaviors.

Thus, given users X (such as 402) connected in an interest graph, the X users likely are more interested in the same advertising as opposed to users who are not. In addition, characteristics and associated characteristics (e.g., via a taxonomy) of those users can be studied and offers, products and other goods/services can be developed specifically for those demographics. This provides a highly personalized experience and also connects a user to users who have characteristics in common. As illustrated, not only different users, but also a user's advertar such as 404 may be incorporated into interest graphs.

### OAuth, ID Verification & Mapping Information to Profiles/Identities

One useful data management tool is OAuth (Open Authentication) which can be applied to Advertar accounts to enable login, ID verification and information sharing (e.g., sharing of a user's interest graph/profile) between accounts of different providers such as different brands like the GAP™ and Costco™. Specifically the tools may allow users to use existing account(s) data such as an account email to sign into multiple accounts of other brand owners without new passwords or require input of new account information such as brand preferences, SWOTE information, deals bought, looked at and other information associated to a profile such as an Advertar.

Another data management tool, identity mapping serves to map information to profiles/identifies. Mapping makes integration of the user's information easier into the brand owner's existing database. For instance, pre-existing user identities such as existing emails in a brand owner's database might end with @amex.com could be easily mapped to addresses with common suffixes such as username.amex.com.Ali.As or any other identifier for ease of mapping integration. This will reduce cost and confusion and consumer reliance on imperfect technologies like email filters. Mapping with domain names takes advantage of addresses on the internet such as domain names, sub-domain names and email addresses which are unique and thus avoids conflict.

In another case, an address ending with @amex.com could be mapped to an address with a different common suffix such as username@amex.com.ali.as. A variety of suffix variations are contemplated that could at least comprise any domain name. For example, in one variation the above address could be username@amex.com.nfluence.com or username@amex.com.0mail.com.

For instance in the latter case above with username@amex.com.ali.as, in the example, a user, Brian has multiple email addresses associated with different vendors (Brian R@amex.com, Round@verizon.com). To allow the vendors a simple way to contact the advertar for their use, it is agreed that a suffix or other differentiator may be added to the email addresses they have for the user so that Amex knows it (or others it wishes to share the new email address with) can contact the advertar for Brian at the new address of BrianR@amex.com.ali.as. Similarly, Verizon knows it can contact the advertar for Brian at Round@verizon.com.ali.as.

The user Brian, can therefore log into a single email server with a single user name/password (here for Amex related emails, the server with the subdomain and domain amex.com.ali.as) and get messages from each vendor from the new addresses created above.

To do the mapping in this embodiment, each vendor or other actor associates the e-mail address or at least a portion of it, for their customers having advertars with appended suffixes such as verizon.com.ali.as which refers to an email server that will receive emails from this domain. On this email server, an audience engine or other server such as the vendor server or a combination of these, a record is kept of each alias email address associated with a particular advertar and the service provider/vendor's (in this case Verizon) email of the user such as Round@verizon.com as well as optional persona information or this information may be stored on a remote server.

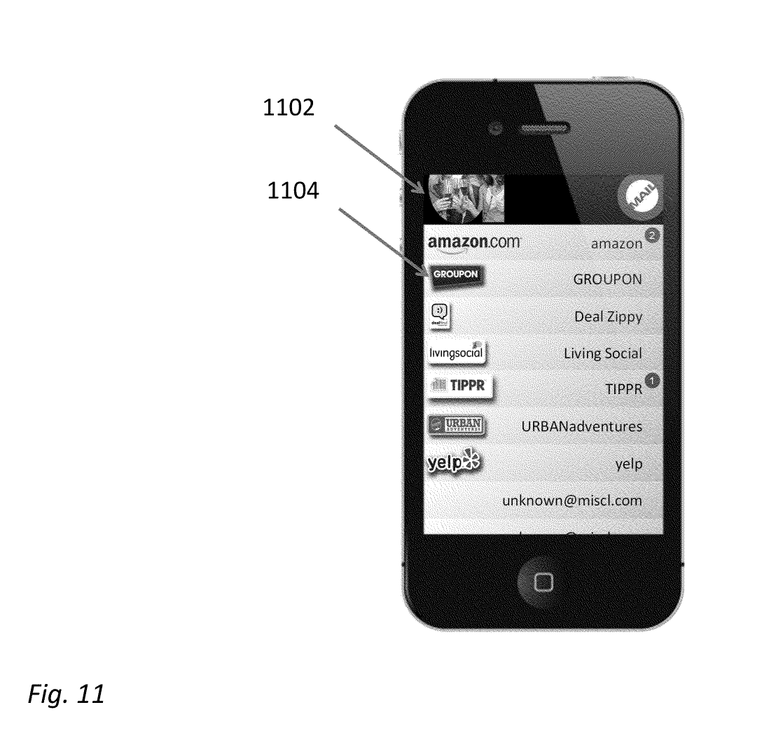

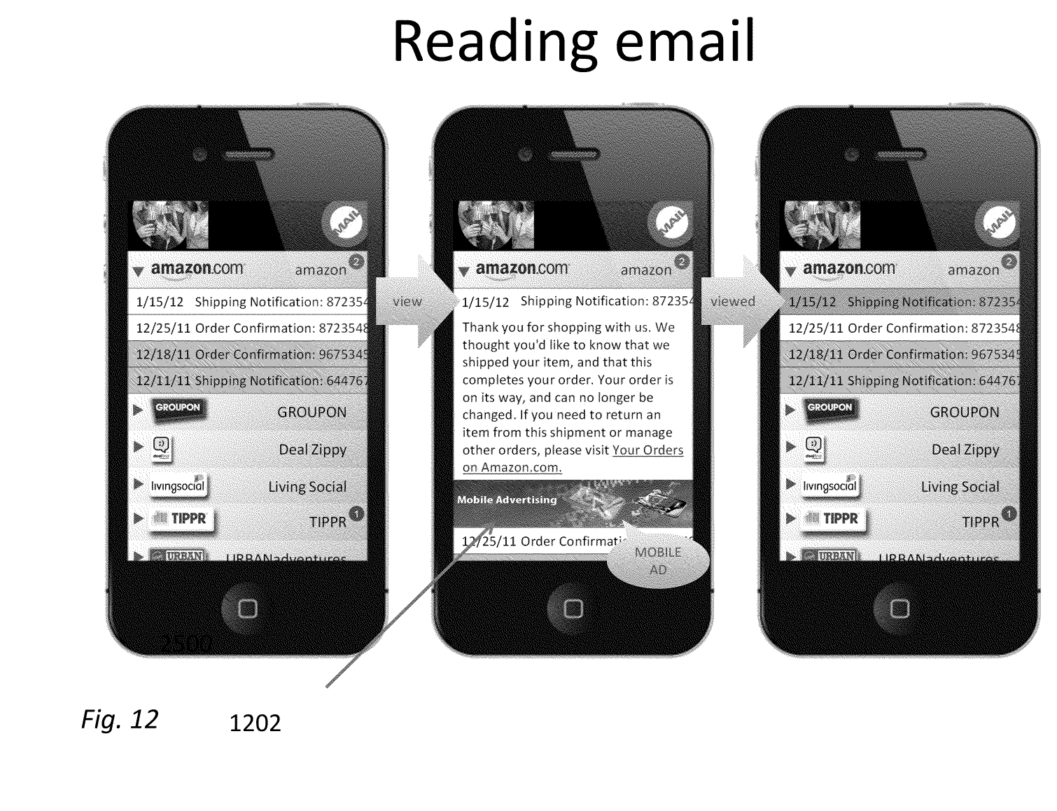

An email client running on the user's device (phone, laptop, iPad etc.) may then log into the alias email and see email sorted by each vendor such as via the subdomain/domain (e.g., the Amex or Verizon in the amex.com.ali.as and verison.com.ali.as respectively) as shown in FIGS. 11 and 12.

These tools make it more convenient for the user to interact with different services such as accounts the user has with different brands. This ease of interaction enhances consumers' freedom between services/brands. For instance, via the disclosed data sharing tools, a user can interact (e.g., login and share her information from her Advertar) with a plurality of brands without laboriously duplicating information for each different brand or take her information altogether away from the brand (by restricting access) or request the information on the brand servers be deleted and then easily share the information to another service as conveniently discussed above e.g., easily migrating from the Apple™ Ecosystem to the Google™ Ecosystem.

In addition, these sharing tools also enhance information sharing between the brand owners themselves via a central profile such as an advertar. This provides enhanced analytics as a profile with information gathered across multiple brands often includes significant consumer information that cannot be collected from a single brand alone. This aggregated data may be shared or auctioned across the brands to monetize the ability to provide the user with more relevant ads etc. This information may also be altered by the user in a like manner.

In addition through these data sharing tools, pre-existing information about each of the users that each brand has (e.g., past purchase information) may be shared with the Advertar profile and other brands which supplements the Advertar profile's existing information such as brand sorting preferences, likes, don't likes, would buy, geographic information, spend graphs etc.

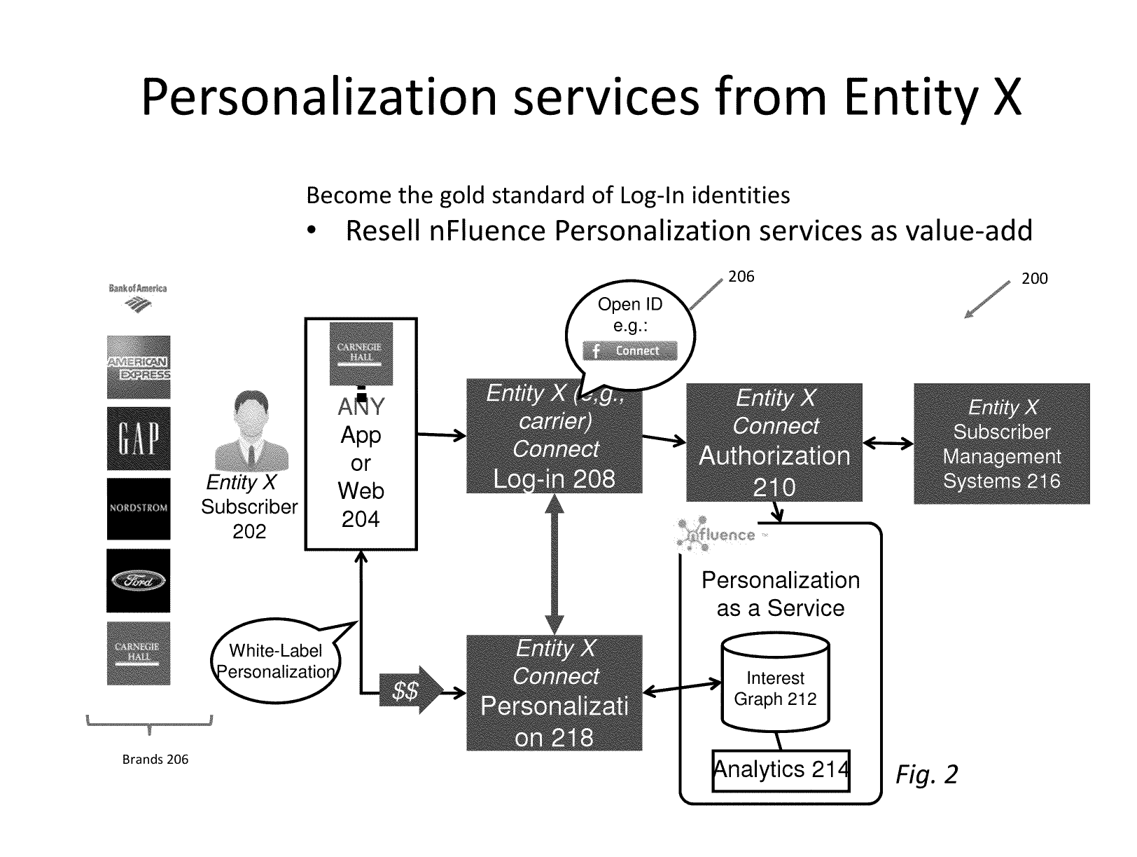

Access to the Advertar or portions of the Advertar may be monetized to brands accordingly. As discussed below in relation to FIG. 2, each brand may take the desired portions of the Advertar they have and personalize their own marketing platforms in order to, for example, offer custom ads to each Advertar user, perform analytics (e.g., mobile analytics), ask further questions based off this information or offer other services to the consumer.

In addition, a verified identity to a user used with OAuth or alternately the use of OpenID or the combination of these tools, across services may be very valuable. Verification with a telecom carrier, advertiser, merchant or other entity is valuable as it may verify the identity of the user, her credit card/history, physical address, social security number, contact information etc. This information may be used as preexisting information to base a profile on—such as an Advertar or be kept private.

A verified ID as discussed above, associated to an Advertar profile also presents a user with an easy way to interact with different brands conveniently by letting her profile (or desired portions of the profile) be shared with each brand to enhance services. On the brand side, the value of this verified Advertar profile is increased in value as payment execution may be conducted since the account is/can be verified which makes contact between the brand and consumer much closer and easier for the consumer to purchase an item. In addition, given this increase in consumer convenience, the consumer will interact more with the advertar, thus increasing the amount of information in a profile which produces a “smarter” profile over time and thus better services to the consumer.

### Identity Mapping

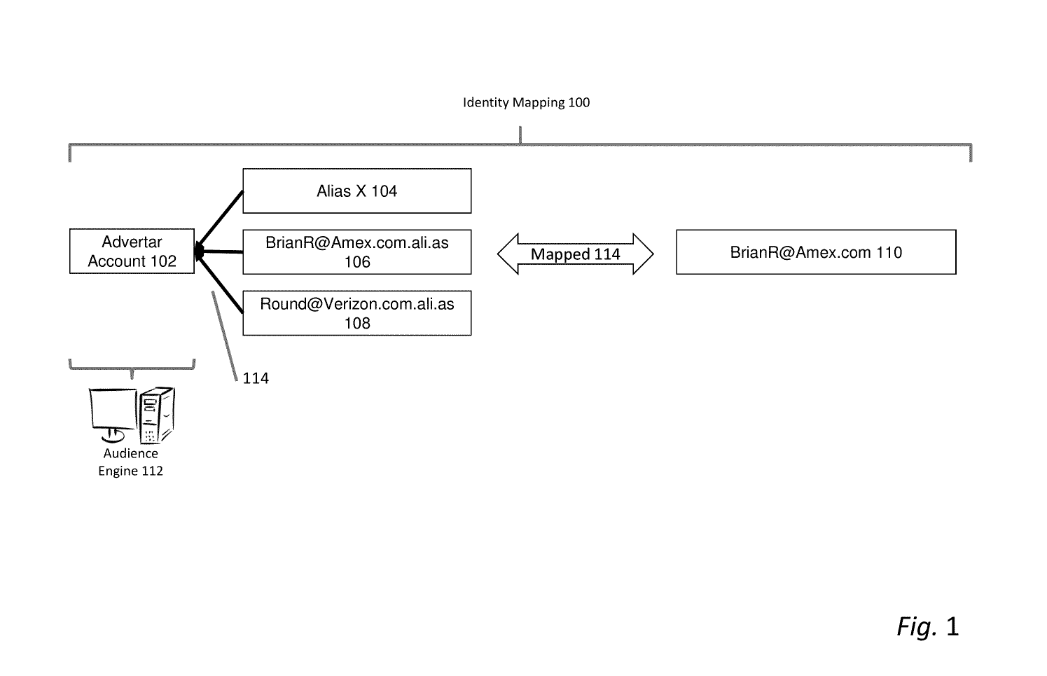

FIG. 1 illustrates an embodiment of identity mapping 100 associated with an Advertar. Here, an Advertar account 102 which may be on audience engine 112 or other server and (discussed the related provisional, utility and international patent applications referenced above) is associated to multiple aliases 104, 106, 108. Alias 108 is round@verizon.com.ali.as while alias 106 is illustrated as brianr@amex.com.ali.as. Here, alias 106 is mapped 114 to an existing account brianr@amex.com 110. In this example, alias 106 was created by using the domain of “amex.com” as a sub-domain- of “amex.com” of the “ali.as” domain. Thus, a new domain of “ali.as” was added to indicate a new server to deliver data to via this address. As illustrated, different brand owners/brands/vendors/service providers may each be issued/generate or otherwise use different aliases that deliver their email to the same domain e.g., Amex was given an alias with an Amex sub-domain, Verizon was issued an email with an alias with a Verizon sub-domain etc. In another embodiment, in place of email addresses in elements 110, 106 and 108 account names (such as just “brianr” in place of element 110), phone numbers or other identifiers/globally unique identifiers, or a combination of these may be used. In yet another embodiment, a separate non-vendor (e.g., a preexisting identifier not issued by Amex or Verizon) issued address such as brianr@gmail.com which may have been associated to the brianr@amex.com account (such as during account creation when he initially signed up with the Amex service) may be mapped to brianr@amex.com which may in turn be mapped as above. Thus brianr@gmail.com may be used in substitution or mapped to brianr@amex.com 110 and/or used to create a new email address: BrianR@gmail.com.Amex.com.ali.as or other identifier as desired.

This mapping provides an easy way for Amex or other brand to take an existing account such as the amex.com account and map it by adding a “.ali.as” or other suffix and integrate it into their database. Address prefixes such as the “local part” may be altered as desired or kept the same. Sharing and/or aggregation of the data tied to these alias/advertar account can be through the third party server at ali.as in which the aliases with ali.as may be interacted with.

In one embodiment, given the above mapping which is recorded and stored at any different number of servers, a user can login into their Advertar account in any variety of ways such as with an advertar email account or a new alias as created above or any other data mapped to this information.

A user may now access the advertar account data through any of the email addresses that may be or have been provided by the brands, a new account directly with the advertar server or other IDs such as those illustrated in FIG. 1 or information associated to the Advertar input at the vendor's servers (assuming the vendor has the mapping and associated data) etc. Thus these may be treated as common IDs of which any can be chosen to access the advertar account and the various brand accounts associated with the advertar. The merchants/brands in possession of each of the accounts may or may not have access to the advertar account or other merchant/brand account information or have partial access as the user sees fit. Access can be determined by how much of the mapping information a particular server has. Thus these tools provide a common credential to be used among for any of the user's accounts.

In yet another embodiment, instead of email addresses, phone numbers may be used in a manner like the above. For instance an area code prefix such as (206) for Seattle, Wash. and/or a country code may be treated similar to a domain above and the remainder of the number may be treated as a username as in the manner the above.

### Embodiments of Identity Mapping

In one embodiment focusing on protecting a user's personally identifiable information that may occur in an email address “local part” e.g. a username@, the following may occur. First a user's existing email such as brian.roundtree@costco.com, which contains personally identifiable information is used as the base to create a new email address. In one example, personally identifiable information such as brian.roundtree is stripped off. In place, is inserted an anonymous ID such as a random identity or a new identity may be created and based off of the original brian.roundtree information through a variety of algorithms/tools. In this example a random sequence: 1234 is chosen to replace brian.roundtree. In addition, a new domain is also added “ali.as” to the new address: 1234@costco.com.ali.as, while the previous domain of Costco.com is now a sub domain of the new address.

The relationships between the advertar account, the brian.roundtree@costco.com account and the 1234@costco.com.ali.as are mapped, recorded and optionally stored on the audience engine or any other device such as the Costco server. Portions of these mappings may not be shared to protect the user's privacy. The mapping of original Costco email, the advertar name and the new address may be stored on the audience engine, Costco server or other device.

Thus this new email may give Costco a direct way to communicate with the user through her advertar. For instance, the 1234@costco.com.ali.as email address may then be provided to other actors, such as other advertisers, which gives them an address to communicate with the user via the ali.as server without compromising the user's real email address brian.roundtree@costo.com or the personally identifiable information contained in this address. Here, the mapping of the brian.roundtree@costo.com address, the advertar and the 1234@costco.com.ali.as email address is not shared with the other actors to preserve confidentiality.

Upon receipt of an advertiser email addressed to the new address at the costco.com.ali.as server, the mapping is accessed and associated to the advertar and optionally the vendor/brand/merchant/service provider/advertiser (e.g., Costco) email. The consumer may login into the costco.com.ali.as server or other server connected and authorized to view and easily manage the emails with her advertar.

Moreover, if spam or other spurious/unwanted email is received at the 1234@costco.com.ali.as address, then the consumer will know that that particular email address from Costco may have been compromised and that email address may be ignored, terminated and another one issued in replacement.

In addition, given that the 1234@costco.com.ali.as address is from a user glancing at the address, clearly associated to Costco.com, the user may instantly recognize that the address is Costco related.

### Additional Mapping Tools

A persona, email, IP address, phone number, device ID, UDID, software ID, software installation ID or other identifying information can be mapped to alternate information for identification and/or other information dissemination purposes.

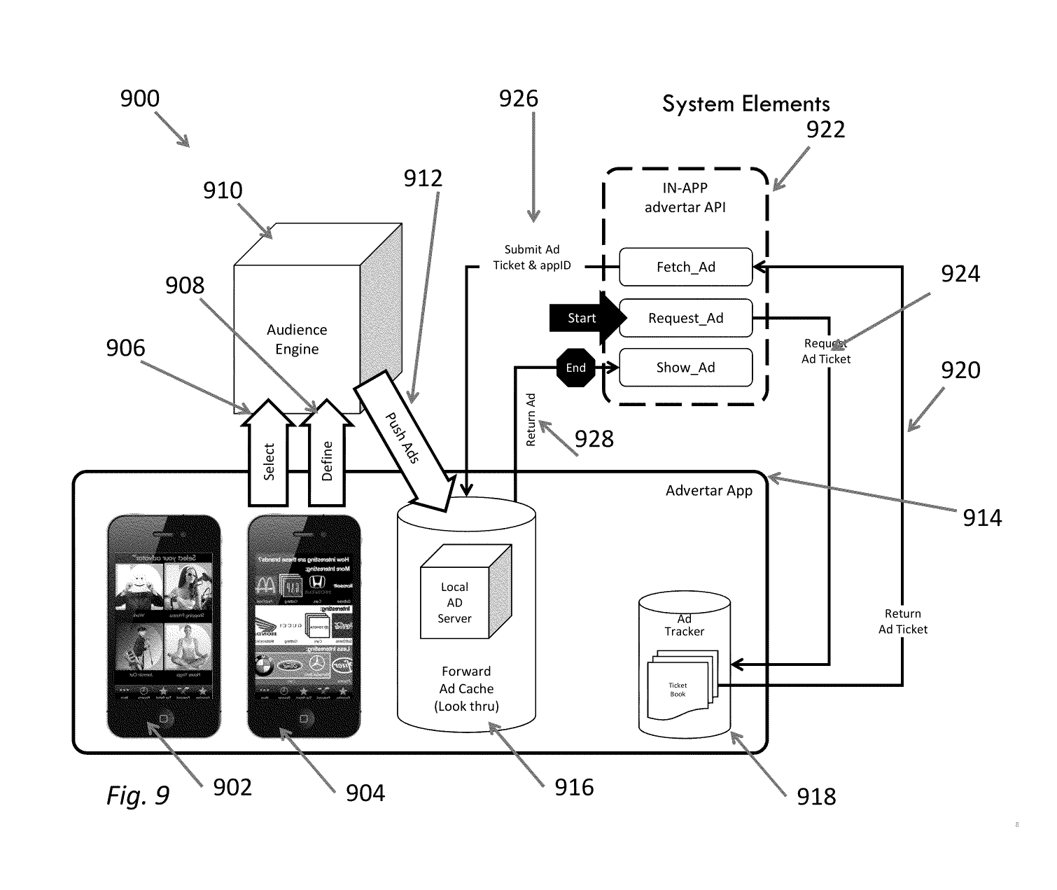

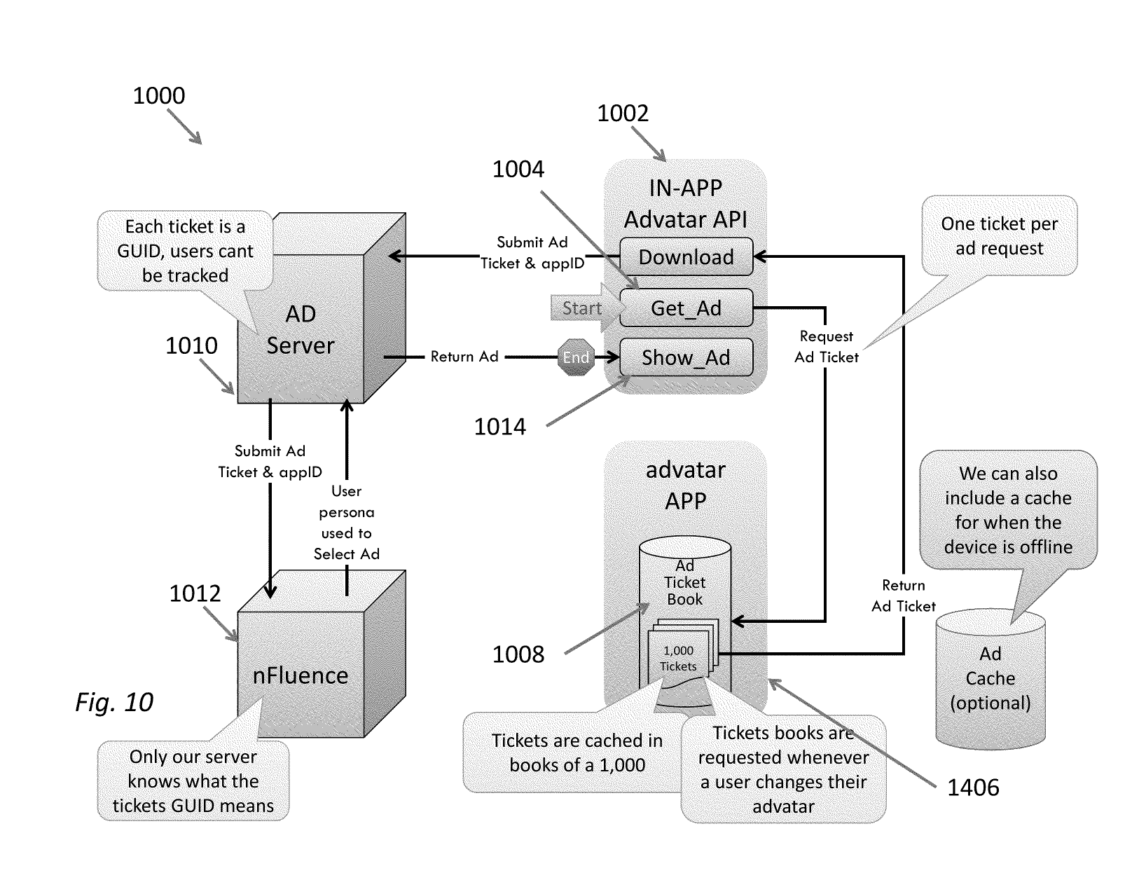

In one embodiment, as discussed in the above referenced patent applications, a persona is created. A user may wish to map/associate her email, phone number, webpage etc. to her persona. For instance, when an advertiser or other entity acquires her email, the advertiser may via the email and identity mapping, examine her persona and target only ads relevant to that particular profile to said email such as illustrated in FIGS. 9 and 10. This may be done by accessing a server such as the audience engine via the user's information to access the persona via the mapping. In other words, the consumer may choose the identifier that a brand may examine and the information the brand owner examines.

In another embodiment, a consumer's home IP (Internet Protocol) address is associated to her profile or other information she desires to be made accessible. The association can be through a central database on any server or may be done at the ISP level. When an advertiser/brand or other entity acquires her IP address e.g., when a consumer interacts with the advertiser's servers, the advertiser may examine her profile via mapping/associations on the above central database (e.g., on an audience engine) before sending targeted information.

In yet another embodiment, the persona can be integrated into a web browser or application (e.g., mobile application) for association by an entity such as an advertiser to a particular user. Here, when the user interacts with a server associated to the advertiser, the advertiser may access the available information in the browser (e.g., such as an interest graph) or stored elsewhere on the client or remotely via identity mapping with her the web browser's software ID or software installation ID and send information tailored to the user's profile.

### OAuth and User Verification

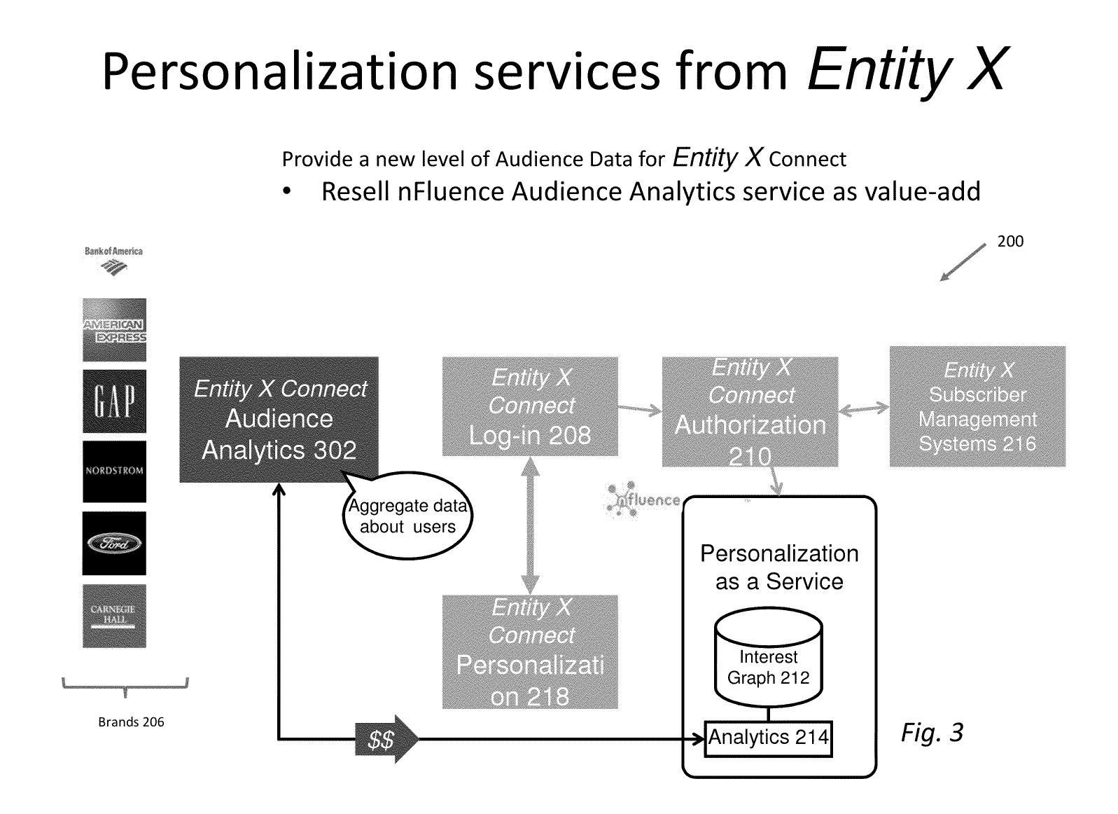

FIGS. 2-3 illustrate an embodiment 200 in which Entity X (such as a carrier, vendor, merchant, brand, service provider, advertiser etc.) interacts with an nFluence server which serves to store Advertars with the tools above. Entity X uses white labeled software, distributes it to consumers to input/collect data, interact with an advertar on an interest graph 212 and resells information to its brand clients such as the GAP, AMEX, etc.

More specifically, FIG. 2 illustrates a subscriber 202 such as a user that is using a brand's white labeled mobile application or web-plugin 204. The user may then enter her ID such as her Advertar, email, IP address, device ID, UDID, software ID, software installation ID or other ID at 204. Via OAuth, OpenID or both, a server such as Facebook™ via Facebook Connect as illustrated at 206 as “f connect” or other similar service/server may verify her login ID by the login at 208. Upon successful login, access to other servers such as an audience engine storing an advertar and interest graph 212 may occur.

At 210, the user may further be authorized which gives the user permission to share the interest graph, parts of it, share information from the account the user is logged into in the mobile application 204, input information etc.

The subscriber management systems at 216 may manage/administer some or all of the operations of this embodiment 200. At 218, the user's interest graph may be examined or supplemented with information from the Management systems 216 or input from the subscriber's application 204. At 218, appropriate ads/offers or content may be determined based off the user's interest graph 212 as discussed in the above referenced patent applications. Once decided, personalization may occur at 218 and the appropriate ads and other content may be sent to the subscriber 202 via application 204.

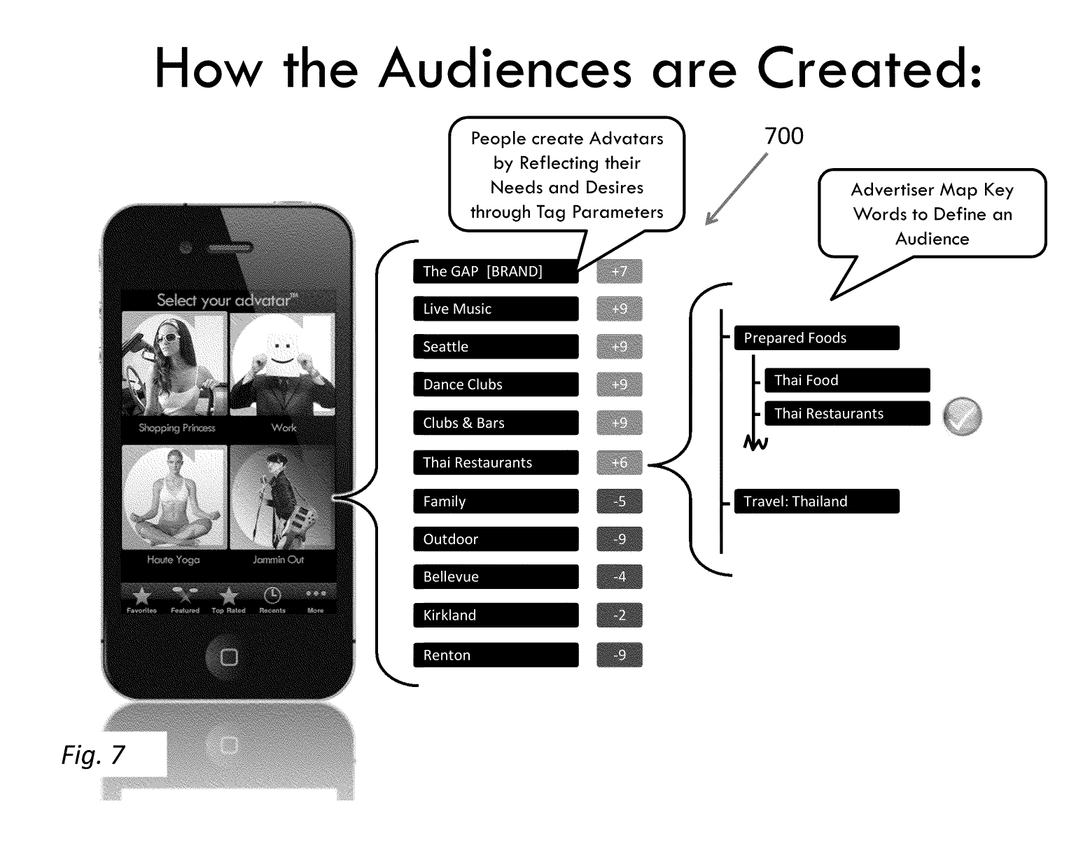

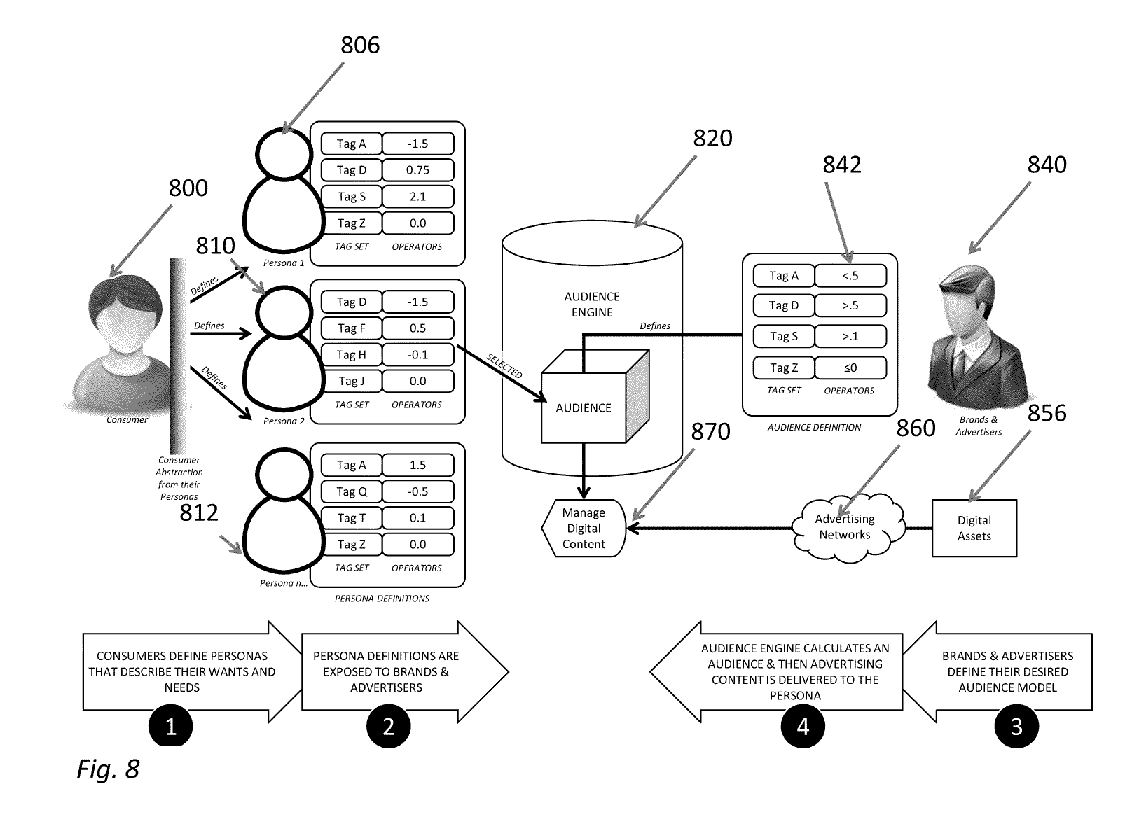

In addition, the audience engine (labeled “Personalization as a Service”) may examine the interest graph 212 for analytical purposes 214 to better learn about the subscriber, the demographics and characteristics she may have, others in the same audience who may share them as discussed in the above referenced patent applications and also illustrated in FIGS. 7, and 8.

Alternately as illustrated, operation 210 may be omitted. Subscriber 202 may login via an OAuth at 208 and at 218, receive personalization such as custom tailored content based on her interest graph 212.

Also as illustrated, the illustrated shapes with “Entity X” may be a brand such as “Carnegie Hall” brand who is illustrated as the distributor of the application 204 or any other brand as in brands 206. As illustrated, the blocks 204, 208, 210, 216 and 218 all indicate “Carnegie Hall” or another brand is operating/managing the various operations from the management systems 216. In another embodiment, some of these operations could be run by third parties such as any merchant, service provider, carrier etc., on various different devices connected by a network. Entity X at 218 and other entities in the figure, may receive compensation for this service in any variety of ways.

As illustrated in FIG. 3, the audience data collected from various users at 214 in FIG. 2, may be aggregated at 302 by an audience analytics server. This data gathered as discussed above from a plurality of users over multiple brands 206 via the illustrated tools (e.g., each brand having its own white labeled mobile application) can be aggregated on the audience engine or elsewhere. Audience data aggregation, analytics and other computations are disused in the above referenced patent applications.

### Alternative to OAuth Verification

In another user verification example, a one-way hash can be used in place of the OAuth at each server the consumer wishes to share her advertar with while allowing her login and other information to remain private.

For instance, a one way hash of an advertar's login credentials such as her advertar name or advertar email address or any other information may be used to create the hash. The hash is associated with her advertar, any address or login and the information that created the hash is discarded. The hash serves to verify that the user entering the original information at least had access to the original information. In other words, the one way hash verifies that a user with access to the information that created the hash is inputting the information. In addition, since the original information was discarded or otherwise kept private, the original information itself cannot be replicated from the hash.

The hash and associated/mapped information such as various account names, emails and other data may then be distributed to various servers that the user wishes to share her advertar with. For instance, Amex, Costco and Verizon may each receive the hash and accompanying algorithm(s) to create the hash and associated data. For example, the hash may be associated to her existing accounts e.g., her Amex email account.

A user may then log into each of the above Amex, Costco and Verizon servers with the information she created the hash with, such as her advertar email account at all of these servers. For instance, upon a user inputting her advertar email and/or password at Amex's website, a hash is created using the same or similar algorithm that originally created the hash before distribution. The input information such as an advertar email at the Amex server or other server is discarded to keep her input private. The resulting hash is compared to the hash that was distributed above. A matching hash is then found via the above mapping to be associated to her Amex email, which is associated to her Amex account. Thus the user has verified her identification and the user may access information on her Amex account, information on her advertar account etc. without compromising her privacy.

An exemplary interface that may be shown to the user while creating the hash is to display the hash being created in real time in response to information she enters. For example if she enters “X” into a device creating the hash by a hashing algorithm, such as a mobile device in communication with the audience engine. Here, in response, to “X”, a one way hash character, “Y” can be displayed which was created by a hash algorithm. Any number of hash creating algorithms may be used to create the hashes.

As discussed in this document, the discussed subject matter solves several technical problems. Specifically solved is the current need by consumer users of email, e-commerce sites and other services provided by brand owners who lack tools to efficiently and conveniently manage information their account information across multiple brand owners. What is disclosed are enhanced and flexible login and profile management tools as well as brand owner communication tools that provide more flexibility in regards to information sharing that benefit both users and brand owners and ease of integration of user information into brand owner databases.

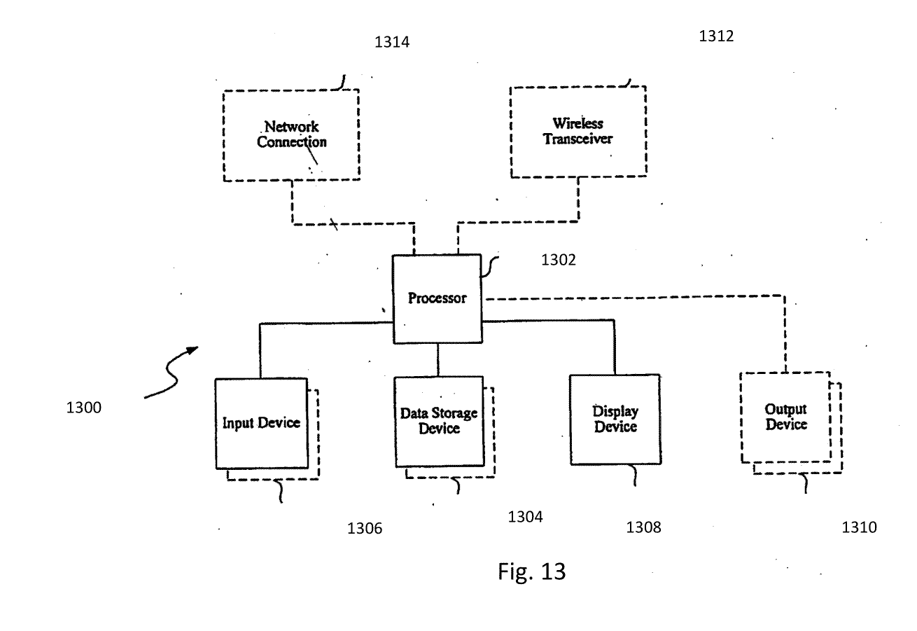

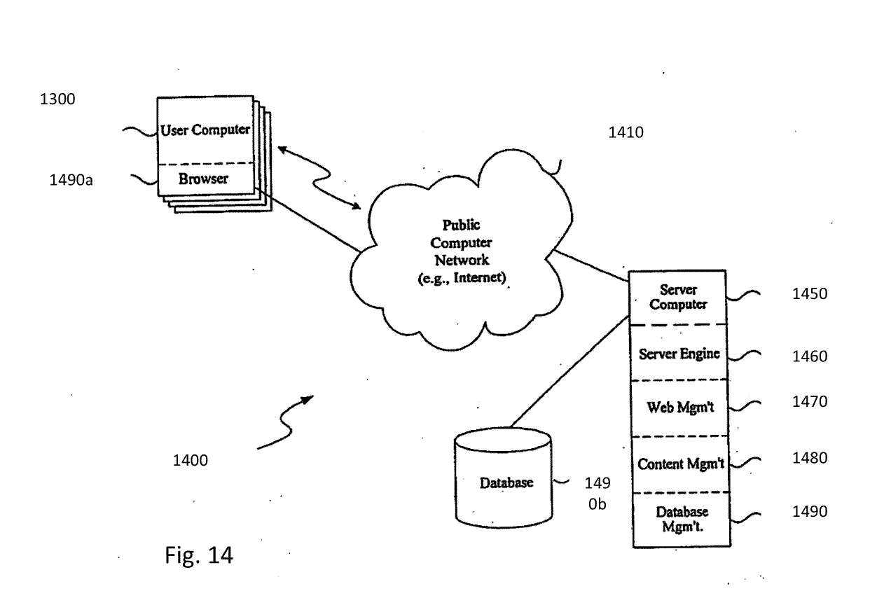

The tools above may be used on any computing device and combinations of computing devices connected to each other as illustrated in FIGS. 13-14. The advertar may be initially created by receiving input from a client device and stored in memory, altered and processed on a local or remote computing device or a plurality of devices in including the client device. Ads and advertar related information can be input and output to these devices from third party computing devices connected over a network.

### APPENDIX A

### Persona Primer

As will be discussed in further detail below, the disclosed technology allows users to create personas (also referred to as “advertars” or “advatars”) to serve as a privacy screen or a barrier between a user and advertisers. In addition, the disclosed technology can serve as a tool to segment a user's interests/communications. A persona may be represented as an icon or other symbol that can be selected by a user and has a number of characteristics (e.g. demographic characteristics) associated with it. The demographic characteristics may represent either actual or desired demographic characteristics of the user. The demographic characteristics associated with the personas can be used by advertisers to determine a target audience for one or more ads. In one embodiment, ads are delivered to a persona but the advertiser does know the identity of the user associated with the persona. Users may have more than one persona that can receive ads. More than one persona can be active at any time or one or more of the user's personas may be programmed to become active based on the time of day, location of the user, current activity of the user, and proximity of the user to objects, other users or locations or other factors.

Personas can be created by the user, copied from other users who have defined their personas or adopted from one of a number of predefined personas. In one embodiment, the demographic characteristics attributed to a persona are determined based on responses to the user's indicated opinions such as likes or dislikes of a number of brands. As used herein, characteristics may include the demographic characteristics of a population such as (gender, age, location, marital status etc.) as well as properties, characteristics or traits relating to single individual users such as a user's individual interests.

In one example a user who wishes to receive ads from one or more advertisers may use the disclosed tools. The user may select or create a persona that serves as a privacy barrier or screen between the user and the advertisers. Ads are delivered to a logical address, such as to an e-mail address that can be accessed by the user's computing device to receive the ads. In another embodiment, ads are delivered to a server computer (not shown) that forwards the ads to the user's computing device so that the user can receive the ads. The advertisers may not know the identity or other personal information of the user other than the fact that the user's persona has one or more demographic characteristics that indicate that the user may like to receive ads of the type presented by the particular advertiser.

In one embodiment, a persona is implemented as a computer record that represents an address or device identifier to which an advertisement can be directed as well as a number of characteristics (e.g. demographic characteristics) that may be input directly by the user or inferred from user input. The aspects of a persona that can be seen by an advertiser may not identify the identity of the user such that the advertiser cannot contact the user directly other than by the address or device identifier associated with the persona. In one embodiment, a persona has a graphic icon that represents the persona and a number of demographic tags or categories representing the likelihood that the user falls in that demographic category or wishes to receive ads that are directed to people in that demographic category.

In one embodiment, separate cookies and caches are used for each persona when using a web browser or other computing device. This segmentation of persona information prevents information cross over between personas. In addition, this segmentation gives context to the information in the cookies and caches given that all data is related to the persona's interests. This makes optional analysis of such cookies and caches more reliable since the user's activities only pertain to the selected persona. Optionally, the cookies and caches can be encrypted to protect privacy.

FIG. 5 illustrates a method by which a user can indicate their opinion of a brand such as if they like a brand either more or less or feel neutral about the brand. As used herein, an opinion may encompass input from any user interaction with or relating to the brand. Such examples include if a user likes/dislikes, purchase/would not purchase, want/do not want as well as if a user is “following” a brand such as following a brand via Twitter™. In the embodiment shown, a user interface screen 500 displays a number of icons 502a, 502b that represent recognizable consumer brands. In the embodiment shown, the interface screen is divided into three areas. A neutral area 504 represents a neutral feeling about the brand (or unfamiliarity with the brand). An area 506 is an area where the user places icons representing the brands they like more while an area 508 is an area into which the user places the icons that represent the brands they like less. Icons representing a number of brands are initially shown to the user in the neutral area 504. Users can then drag and drop the icons into one of the other areas 506, 508 to indicate that they like the brand more or less respectively.

In the example shown, a user has selected the icon 502(b) representing the brand “Fendi” from the neutral area 504 and has dropped it into the area 506 in order to indicate that the user likes this brand more. If the user has no opinion of the brand or is neutral about the brand, the user can leave the icon in an area of the screen 504 that groups icons for which no opinion has been expressed. Alternatively, icons representing brands for which no opinion or a neutral opinion is expressed can be removed from the screen and replaced with another icon representing another brand. Based on the opinions of the user to a group of brands, an estimate can be made of the likelihood that the user has one or more demographic characteristics (or would like to receive ads directed to users having those demographic characteristics). In some embodiments, brands that are left or placed in the neutral area of a screen may also be included in determining likely demographic characteristics in a variety of ways. For instance, if a user has relatively consistent neutral/unfamiliar opinion towards upscale brands such as Rolls Royce™ and Saks Fifth Avenue™, it may be inferred that the consumer is neutral/unfamiliar to the brands because her income level is likely not in the range of consumers who are exposed to these brands.

In an embodiment, upon selection of a brand such as an upscale brand (e.g., Rolls Royce) an inference could be made that the user is a high-income user. In response, a subsequent brand sorting screen may be presented with additional upscale brands to confirm the inference and determine other likely upscale demographic characteristics. For instance, if in the subsequent brand sorting screen, a user declined selection or voted down of all of the subsequent upscale brands, then an inference would be made that the user is a “aficionado” of expensive cars, but not a “big spender” across different types of categories such as spas, airplanes etc.

In the example shown, the brands represent known manufacturers or providers of goods or services that the user can buy or use. However for the purposes of the present application, the term “brand” is meant to be interpreted broadly. A brand may include, but is not limited to, a logo, trademark, animation, text, movies, movie clip, movie still, TV shows, books, musical bands or genres, celebrities, historical or religious figures, geographic locations, colors, foods (e.g. packaged foods), flowers, animals, designs, characteristics (young, old, short, tall), emotions (angry, bored), political views, color combinations, shapes, graphics, sounds, movement, smells, tastes, slogans, social media users, personas, patterns, occupations, hobbies or any other thing that can be associated with some demographic information. For instance any thing that can be broadly accepted or recognized by a plurality of users can be a brand. In addition, anything that can identify a seller/product/service as distinct from another can be a brand which may include Huggies™ brand diapers, Copper River Salmon, Microsoft™ software, a picture of Tom Cruise, a picture of a frame from one of Tom Cruise's movies, a musical band name, a musical band album cover, a famous picture such as the picture from Time magazine celebrating victory in WWII in which a sailor is kissing a woman, a picture of a house in the country, a picture of a Porsche™ car, a picture of a smiley face as well as concept brands such as breast cancer awareness or environmentalism etc. In addition, a brand can be an abstract idea such as “World Peace”, “Save the Whales”, political ideologies such as “Republican” or other concepts about which a user may have an opinion.

In one implementation, each persona is associated with one or more tags representing different characteristics such as different demographic characteristics. The association may be determined via the brand sorting during persona creation. A tag may store or be associated with a value that represents the likelihood (e.g., a probability distribution) that the demographic characteristic represented by the tag is applicable to a user. For instance, the value of the tag may reflect a probability that the user is male while another tag represents the likelihood that the user lives in New York. Other tags may store values that represent the likelihood that the user has children, likes Chinese takeout food, and votes Democratic etc.

Based on the user's indication of their opinion of the brands, such as if each brand is liked or disliked, the tag values can be combined into a composite value that reflects that likelihood that the user has a particular demographic characteristic. As an example, assume that a user indicates that they like Ford brand trucks, Remington brand shotguns and Golden retriever dogs, while another user indicates that they like Barney's of New York brand clothes, Vogue magazine and miniature poodles. Here, the first user likely has a higher probability of being a male than the second user when one compiles the composite values of the probability distributions associated to the gender demographic associated to these brands. A different composite demographic can be associated with the persona created for each user. A user may also reuse composite demographics for multiple personas preventing repetitive entry of opinions. Advertisers then use these determined demographic characteristics to decide which personas should receive their ads. Brands may be selected for presentation to the user for brand sorting based on the likelihood of a user having a certain a certain demographic characteristic. For example, selection of a cosmetic brand X likely indicates a female user in which more brands relevant to females may be presented.

In one embodiment, the composite demographic information is created from the group of brands that are sorted by the user based on her opinions of the brands. In the example shown in FIG. 6, a user indicates that they shop for (e.g. like) brands 1, 2 and 4. The user has indicated that they don't shop for (e.g. don't like) brand 6 and are neutral towards (e.g. don't like or dislike or are unfamiliar with) brands 3, 5, 7, and 8. In one embodiment, the tag values representing the likelihood that a user has a particular demographic characteristic are combined depending on if the brand is liked or disliked. In other embodiments, buy/not buy, would buy/would not buy, use or would use, do not or would not use as well as other opinions or impressions can be presented alone or in combination.

In one embodiment of the disclosed technology, the tags for the brands represent the same demographic characteristic. For example, Tag 1 for all the brands may represent the likelihood that the user is a male between ages 25-40, while Tag 2 may represent the likelihood that the user is a male between ages 40-55. Tag 3 may represent the likelihood that the user is a woman between ages 18-22 etc. Each tag has or is associated with a value representing the likelihood of a user having a defined demographic characteristic. These values for the tags are typically determined from information gathered from consumers who volunteer information about themselves and what brands they like, purchase etc. Such information is typically gathered from marketing data from consumer surveys or a variety of other data sources. The details of associating consumer demographic information with particular brands are considered to be well known to those skilled in marketing. In other embodiments, users may assign a value to a brand by inputting the value itself into the computing device, assigning a relative value to each brand and or tag (brand X given a higher preference to brand Y by giving brand X a location assignment a screen above or to the right of brand Y) etc.

Not every brand may have the same set of tags associated with it. For example Brand 1 does not have a Tag 4, while Brand 2 does not have Tags 2 and 6 and Brand 6 is lacking Tags 3 and 4.

In one embodiment, the composite demographic characteristics for a persona are created by arithmetically combining the values of the tags for the liked and disliked brands. In the example shown, Brands 1, 2 and 4 are liked so their tag values are summed while Brand 6 is disliked so its tag values are subtracted. When combined as illustrated, Tag 2 has a summed value of 4.0 (1.5 plus 1.5 minus (−1.0)). A value of 4.0 for a tag may represent a strong likelihood that a user has the demographic characteristic defined by the tag. On the other hand, a tag with a combined value of −2.5 may provide an indication that the user probably does not have the demographic characteristic associated with the tag and an inference can then be made. For example, if a composite gender tag value suggests the user is likely not a male, an inference can be made that the user is a likely female. A composite of the values of the brand tags across the brands (e.g., the sum of statistical probabilities of tag A across brands X to Y as seen in FIG. 6) may also be represented by a vector that is associated with the persona. Each brand tag value in FIG. 6 may be a dimension of the vector.

In one embodiment, based upon the composite demographic characteristics, the corresponding user or persona may be placed into pre-computed demographic segments. Such pre-computed segments are typically determined from marketing survey data. Once the user is assigned to the segment, additional associated characteristics of the pre-computed segment may be associated to the user. In addition, ads that have been specifically designed to target the pre-computed segment may be delivered to the user.

In one embodiment, an ad/offer/content that a persona may be interested in receiving may be matched with the persona based on said persona vector. Typically an ad comes with tags such as coffee, sale, spa, dancing lessons etc. Here, an ad/offer's tag values may be assigned based on marketing data taken from consumer surveys such as a probability distribution that a certain demographic (age, sex, income etc.) would likely desire to receive ads with a given ad tag. The composite of ad tag values represent a vector for the ad. Each of these offer tag values may therefore be considered as an ad vector dimension. In one embodiment, tags related to the ad tags may be assigned along with their associated values to aid in ad-persona matching.

Once a persona is defined, a plurality of ads can be ordered for presentation to the user according to likely persona affinity. By calculating the distance between the persona vector and the ad vector, such as their distances in N tag space, ads can be ranked in order of likely persona desire. The result of this distance calculation may be a ranked list of ads in order of affinity (i.e. the distance between the vectors) for a particular persona vector. In this manner, instead of filtering out ads, a relative ranking of ads is produced. Alternately, other distances between the ad and persona vectors (or any of their components) can be calculated to produce a ranking. Various other methods of ad filtering and ad sorting to match the appropriate ads to the persona may also be used. In some embodiments, location, past purchases, sale times/items, membership in customer loyalty programs, percentage off and other factors may be used to aid in ad ordering/selection. In one embodiment, the calculated affinity for a particular ad is displayed to the user as stars (e.g., an ad with a highly calculated affinity is four our of four stars etc.). In another embodiment, the ordering/filtering may consider the ratio of the geographic distance to an offer and the percentage off. For instance, if an ad is only 10% off and the distance is several hundred miles from the user, this ad would have a lower ordering then an ad that is 90% off and one mile away from the user. Here, the distance and percentage off etc., may be displayed to the user as well. In yet another embodiment, the persona may keep track of ads that resulted in a purchase by the consumer. After a purchase, the user will not be shown the ad on the persona that made a purchase or on all her personas.

Optionally, the dimensions on the persona vector and/or the ad vector can be normalized by multiplying the dimension by a scalar between for instance, zero and one, to prevent particularly strong tag dimensions from skewing the results.

In one embodiment, the composite persona demographic information is determined locally on the user's computing device with which they indicate their preference or opinion regarding various brands. In another embodiment, the opinion information such as like/dislike indications about presented brands are sent to a remote computing device, such a web server that determines the composite persona demographic information. If sent to a remote computer, the remote computer can return a persona back to the user's device.

### Audience Selection

In one embodiment, once a user has created or adopted one or more personas, the personas are registered with a server computer that maps a persona to one or more addresses or other identifiers to which ads should be delivered. As discussed above, the address may be an e-mail address, IP address, device id., web site or another logical address that can be used to direct ads to the user.

As shown in FIG. 7, a selected persona defines one or more demographic characteristics 700 (such as interests like That food) that may be of interest to advertisers in selecting a target audience to receive their ads. In the example shown, the persona “Jammin Out” has a +6 value for the tag that reflects an affinity for That restaurants. Advertisers looking for potential customers of That food, That restaurants, and trips to Thailand etc. may search for personas having a relatively high number for this tag in order to select a target audience for their ads.

In addition, FIG. 7 illustrates a taxonomy expanding the user's interest tags. For example, the user has rated That Restaurants a +6. As such, the user would probably be interested in prepared foods in general as well as That foods and perhaps even travel to Thailand. These relationships can be from user survey information. The new tags and associated values can be assimilated into the persona. This expansion of tags provides the user the opportunity to see additional topics, brands, times, locations and other related information. In addition, a user may give feedback on the tag's desirability and associated value.

FIG. 8 shows further detail of one embodiment of a system for matching tag values for a number of personas with an advertiser's needs for a target audience. In the embodiment shown, a user 800 defines a number of personas 806, 810, 812 each having different tag values that represent different characteristics such as demographic characteristics. The persona information is sent to an audience engine 820 via a wired or wireless computer communication link. The audience engine 820 stores the persona information in a database. An advertiser 840 supplies the audience engine with a list of demographic characteristics such as tags and associated values they want in a target audience. These demographic characteristics are coded manually or with the aid of a computer into one or more tag values 842 or ranges of tag values. The database of personas stored by the audience engine 820 is then searched by the computer system to determine those personas having tag values match all, or as many as possible, of the desired demographic characteristics. Once the personas have been identified, ads 856 are supplied from advertising companies 860 to the audience engine 820 that in turn forwards the ads to the addresses or identifiers associated with the identified personas. Alternatively, third party advertising companies and/or the audience engine 820 may deliver the ads to the personas.

Ads may be displayed to users on the same device on which brand sorting occurred or on multiple different devices. The ads may be shown on these devices within a specified amount of time or upon an event trigger such as proximity to a merchant's store, the start of a sale, another user expressing interest in the ad etc.

In FIG. 8, brands & advertisers can also gather personas from multiple users. These personas can also be processed through steps 1 and 2 in which the yield is similar to the single user persona case but over multiple users. In either case, an advertiser can determine audience or single persona/user trends, similarities in buying habits, and buying locations etc. Advertisers 840 can get anonymous predictions (without user identity) regarding predictions which are useful in displaying particular customized ads, persona/user interests in ads and associated products, or ordering inventory in anticipation of purchases. Typically an advertiser 840 would be charged a fee by the audience engine 820 for displaying an ad and receiving marketing data pertaining to target audiences. In one embodiment, an advertiser or other party may analyze the persona information to discover and target new audiences.

Audiences and personas may be accessed and transmit data to the audience engine 820 on multiple applications across multiple platforms and devices. Typically each type of these interactions may communicate with the audience engine 820 using an identifier that represents the user's persona. As such, simultaneously use of a single persona may be permitted. Advertisers 840 may be charged for varying access to personas or audiences across various devices, platforms and applications. For instance, an advertiser may be only permitted and thus only charged to access certain personas in an audience using an iPhone™ or access can be restricted to audiences using certain iPhone applications.

In one embodiment, the audience engine 820 tracks the active time a user spends on each persona, actions/choices/votes/location/sharing of ads of the persona, ads voted on, purchases, click-thrus, impressions, advertising effectiveness, which application was used with the persona and which device(s) was used with the persona. This tracking may be confidential and not revealed to third parties without consumer permission. The user may be offered a reward such as money, points, gift cards in return for sharing this or other data. In another embodiment, the user may chose to share this data with selected personas owned by others or herself which results in a real-time sharing of her actions.

In one embodiment, the demographic information associated with a persona is refined depending on how the user reacts to ads delivered to the persona or previous brand sortings. For example, if the user indicates that they do not like an ad, one or more tag values associated with the persona may be adjusted. In this way a persona's determined demographic characteristics can be continually improved or updated. In one embodiment, ads can be shown as icons and displayed and assigned affinity/voted on in a manner similar to how brands are sorted as illustrated in FIG. 5. Answers such as “like the ad” “neutral” and “dislike the ad”, a picture of a “thumbs up” and “thumbs down” may be displayed on various screen areas so the user may know where to drag the icons to and thereby assign affinity to the ad.

In one embodiment, the feedback from user assigned ad affinity may make very granular adjustments to a persona. In one embodiment, a simple vote on an ad may modify a plurality of aspects of a persona by considering the specific tag, subcategory tag and associated weights among other things. For example, an ad was voted “thumbs up” and the ad had the following tags and associated values: car=1, car/Ford=0.2 and car/Toyota=−1 wherein car is a category tag and Ford and Toyota are subcategory tags. The persona could be modified in a plurality of ways. First, the persona would favor these tags and subcategory tags in a greater absolute magnitude than if the ad was voted “thumbs down”. This prevents undue voting down because users are more expressive about things they like as opposed to things they don't like. Second, a variety of tuning factors may be applied to the tags “car” or subcategory tags “Ford” and “Toyota”. For example, categories may not all be weighted equally. In one example, categories may be weighted differently for different cultures. For instance, the automobile category may receive a higher weight in US culture as opposed to cultures where automobile ownership is lower.

If an ad was assigned a negative affinity, the tag and associated values may play a lessor role in assigning ads in the future. In one embodiment, no ads with those tags or related tags might be shown to the user. In another embodiment, ads with these tags and related tags might be decreased but reintroduced to the user at a gradual rate to ensure the user does not permanently omit herself from exposure. In another embodiment, the ads with said tags and related tags simply have their weights reduced accordingly. Similar approaches to the above can be applied to brand sorting.

### System for Delivering Ads to Personas

FIG. 9 illustrates an exemplary system 900 for creating personas and ad serving to a persona on a computing device. As used herein, the term “ad” is to be interpreted broadly and can include promotional materials, rebates, consumer notices, content, political or religious materials, coupons, advertisements (including push advertisements), various kinds of recommendations (such as product/service recommendations, content/media recommendations), offers, content (movies/TV shows) and other information that a user may which to receive. At 902 a mobile device is shown. On the screen are images representing four personas tied to a single account. A user may optionally register the account under any identifier including an email address. In one embodiment, the email address is one way hashed and discarded after the hash. The hash is optionally stored by the audience engine and serves as an identifier. This prevents the storage of user's identifying information on non-user devices and enables the user to have an identifier in case she forgets her password etc. In another embodiment, only one persona is created and no identifier is asked from the user. Instead, a software install ID or other identifier is used to identify the persona.

A persona may be created by optionally choosing a name for the persona, associated interests/keywords (e.g. to help focus ad searches), social media accounts to tie the persona to and active locations/times the persona should be active among other parameters. Then, a brand sorting screen may be displayed at 904. Upon sorting a number of brands, at 906 and 908 the brands that define the persona are transmitted to an audience engine 910, which may be on a remote server.

The persona's demographic characteristics are matched with ads, offers, coupons, services, products, content recommendations or other similar things. Typically, the audience engine 910 is in communication with a third party ad server and/or ad bidding system (not shown). The ads may be pre-downloaded to the audience engine 910 and analyzed. Analysis may be performed by assigning tags and associating statistical probabilities that particular demographics would be interested in the ads or assigning probabilities to existing tags or other data related to the ad. The ads are then optionally ordered in relevance to the characteristics of a particular persona's vector as previously discussed. Here, in response to the persona creation, a plurality of ads are pushed to the mobile device at 912 from the audience engine 910. The ads are pushed into a local ad server 916 on the user's computing device. Here the local ad server is within the application 914 that created the persona. Within the application 914, is an ad tracker 918 with a ticket book. Each ticket may be used to request an ad from an in-application persona API 922. In one embodiment, a ticket may contain information to display an ad to one or more personas and/or to different devices or applications associated with the persona.

The request for an ad may occur upon a user or a software request or on the occurrence of an event such as an arrival of the device at a physical location, keyword in communication, predetermined by an advertiser, event on a calendar, time of a TV show, a triggering event such as visiting a website, date of a product sale etc. API 922 may start the ad request at 924, which is transmitted to ad tracker 918. Ad tracker 918 returns a return ad ticket at 920 to API 922. API 922 then submits the ad ticket and application ID at 926 to the local ad server 916. The local ad server then displays the ad on the device or other connected devices at 928. In one embodiment, the application ID at 926 can be directed toward other applications on a plurality of connected devices in order for an ad to be shown on other devices. Optionally, upon display of the ad, at 926 a request can be made to a connected device to display other content such as a website related to the displayed ad or the ad itself on other devices.

### Masking User Identity

FIG. 10 illustrates a system 1000 in which a user's identity can be protected from being discovered during persona advertising. In one embodiment, a GUID or other non-traceable ID, such as a software install ID, is assigned to each user/persona and this information is optionally associated with an IP address as the only information shared with advertisers etc. At each exposure point, a new GUID may be assigned to prevent identity triangulation. In one embodiment, GUIDs are automatically changed even on the same visit at every exposure point for added privacy.

At the start operation, the in-app Advatar (persona) 1002 (typically stored on the user's device within an application) has a Get_Ad 1004 software module which requests a ticket (each ticket may contain a different GUID(s)) from an Advatar app 1006 on any desired device connected to a network. The Advatar app may cache a plurality of tickets in an ad ticket book 1008. The in-app Advatar 1002 is designed to request/receive and display ads via tickets and optionally designed to accept persona feedback on an ad and the persona's actions.

The ticket requested by the in-app Advatar 1002 is sent from the Advatar app 1006 to the in-app Advatar 1002 with which the ticket is then associated with an application ID. The application ID is then sent to an advertiser's ad server 1010, an ad exchange or real time bidding system. In one embodiment, different tickets may optionally correspond to tickets to show different personas ads. From there, the ad ticket and appID is passed to a secure third party server (e.g., audience engine) 1012 in which this sever, and optionally not the advertiser's server, knows what the ticket GUID means in terms of the user's identity or other sensitive information e.g., profile etc. Another use of the GUID is that users may appear simultaneously as different GUIDs on different devices in a secure manner. For example, advertising server A would see the GUID as 1234 and the same user is seen on advertising server B as user GUID 4567 but only the server 1012 would be able to determine the true identity of the user. The apparent GUID may even change periodically while accessing the same website (server 1012 will periodically assign a new GUID). The secure third party server 1012 would coordinate the information with the correct master ID as only it knows the corresponding GUIDs and identity/persona information. This protects the user from unwanted contact from advertisers such as SPAM as the advertiser has no email or other personally identifiable information. Although in one embodiment, the ad server 1010 has the user's IP address in order to return an appropriate ad to the persona.

Given the persona profile on the secure third party server 1012, an appropriate ad or kind of ad is determined. The appropriate type of ad is then communicated to ad server 1010. The advertiser's server 1010 then forwards the appropriate ad determined by the secure third party server 1012 to the in-app Advatar 1002 via an IP address that the in-app is hosted on. Once at Advatar 1002 a Show_Ad module 1014 then displays or caches the ad for later display. Various other software embodiments are contemplated for masking a user's identity.

### Brand Sorting Embodiments

In the embodiment shown in FIG. 5, a plurality of brands are first displayed in the neutral area 504 for sorting into the other areas or to be left in area 504. Brands may be presented to a user based upon statistical market research and the desired attributes to be collected. For instance, a “like” of the Huggies Diaper™ brand may suggest a high probability distribution that one is a parent. Selection of Huggies and Toys R' US™ brand may further confirm that one is a parent. Brands may be suggested to a user based upon sites or actions that the user has engaged in, installed apps, keywords or senders/recipients in communications, geographic history (infers you have visited a location related to a brand with a mobile device), contacts/friends, current or future locations, interests etc. Each of the brands may be weighted as desired to help determine desired characteristics.

Upon brand sorting, ads and other recommendations can be displayed to a user. Upon ad feedback, the user may be displayed another series of brands (or ads) to vote on for a finer granularity of recommendations. In one embodiment, this ad voting may adjust values of a single persona vector or even multiple personas. For instance, a demographic dimension within the vector may be voted up or down by a desired amount depending on how an ad is voted. For instance, if many ads that are targeted to a certain demographic are voted up, then that demographic dimension in the persona may be adjusted up. However, to prevent a single dimension within a persona vector from unduly influencing the entire persona vector, dimensions can be optionally bounded.

In another embodiment of the brand sorter, different opinions can be asked depending on the desired context. The chart below illustrates some examples:

| | Brands | Advertising | Offers |
|---|---|---|---|
| Up | Like | More Like This | Save |
| Neutral | Don't Care | Don't Know | Neutral |
| Down | Dislike | Less Like This | Discard |

Different combinations and actions can be taken from the above chart. For instance, if a brand is “disliked” the brand's associated values may simply be weighted down in the persona. However, if a brand is not liked, the brand's associated values may be completely discarded. In addition, any associated tags may be flagged as not suitable for the consumer at all. Alternately, this “unsuitable” data may only be discarded for a short time and gradually be reintroduced to the user.

In other embodiments additional information may be displayed to the user during brand sorting during drag and drop selection. For example, as the icon 502b in FIG. 5, is selected by a user with a finger and is gradually moved from its initial position, the initial position may be occupied with “peek text” that serves as information in the space formerly occupied by the icon which may display additional information such as the name of then brand in text etc.

### Monetization Embodiments

FIG. 8 also illustrates a system for monetization of the personas. Here audience engine 820 produces an audience of users whose personas fit a desired brand or advertiser definition such as coffee drinkers who live in Seattle and who are over 30 years old, which is gathered or inferred from brand sorting or other techniques.

The advertiser or brand 840 can then use the resulting persona data from the audience engine 820 to analyze their products, ad performance, marketing strategy against any desired audience. Product ad effectiveness to a persona(s) in desired audiences can be ascertained by comparison of common and/or related tags between the persona and the ad tags and associated tag values. Analysis could comprise analyzing user votes on the ads, if the ad was clicked on by the user, if a product was purchased etc. A fee could be charged for such services to the advertiser 840.

### Email Accounts and Personas Embodiments

In one embodiment, under a single user account, each persona may be associated with a separate email address. This permits the user to have an email address focused specifically on a single persona. Each persona my have the ability to decline/filter communications according to keyword, sender, dates or other criteria to prevent the persona from being overwhelmed with unsolicited communications.

As illustrated in FIGS. 11-12, a persona may be associated with an email program and an address to help organize information. New email addresses may be created by appending information to existing email addresses. For instance, if an email is brian@roundtree.org, a new email address for a persona may be brian@roundtree.org.0mail.com or other methods can be used to create new email addresses.

The persona 1102 may access an email program as shown in FIG. 11. The email program may group persona emails by domain 1104 and may associate an icon and company name upon domain recognition. An active persona icon 1102 may also be displayed.

An arbitrary level of importance assignment may be featured in which high importance messages such as password assignments are given certain levels that are marked next to the domain “level 1” indication and lesser important emails are given lesser importance levels.

FIG. 12 illustrates functionality of the email program for a specific persona. Here, emails are listed by domain, assigned importance levels and may be read. At 1202, advertising can be directed in the email program using technology discussed in this document. Optionally, the advertising may be based on the active persona and/or related to the subject of the message being read. In addition, once the email is read, it is marked as viewed.

### Description of Computer Hardware

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

A non-transitory, computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium also can be, or can be included in, one or more separate physical components or media (e.g., multiple CDs, disks, or other storage devices). The operations described in this specification can be implemented as operations performed by a data processing device using data stored on one or more computer-readable storage devices or received from other sources. A representative data processing device is shown in FIG. 13.

The data processing device includes “processor electronics” that encompasses all kinds of apparatus, devices, and machines for processing data, including by way of example a programmable microprocessor 1302, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices 1304 for storing data, e.g., flash memory, magnetic disks, magneto-optical disks, or optical disks. However, a computer need not have such devices. Moreover, a computing device can be embedded in another device, e.g., a mobile telephone (“smart phone”), a personal digital assistant (PDA), a mobile audio or video player, a handheld or fixed game console (e.g. Xbox 360), a Global Positioning System (GPS) receiver, or a portable storage device (e.g., a universal serial bus (USB) flash drive), to name just a few. Devices suitable for storing computer program instructions and data include all forms of volatile or non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device 1308, e.g., an LCD (liquid crystal display), LED (light emitting diode), or OLED (organic light emitting diode) monitor, for displaying information to the user and an input device 606 such as a keyboard and a pointing device, e.g., a mouse or a trackball, track pad etc., by which the user can provide input to the computer. In some implementations, a touch screen can be used to display information and to receive input from a user. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser. The data processing apparatus 1300 may also include a wireless transceiver 1312 such a cellular radio, WiFi or WiMax transceiver, Bluetooth transceiver and a network connection 1314 etc. The data processing device may also include an output device such as a printer 1310. In addition, the device may include location sensing devices (GPS etc.), as well as clocks and other circuitry (not shown).

As shown in FIG. 14, embodiments of the subject matter described in this specification can be implemented in a computing system 1400 that includes a back-end component, e.g., as a data server 1450, or that includes a middleware component, e.g., an application server, or that includes a front-end component, e.g., a client computer 1300 having a graphical user interface or a Web browser 1490a through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a wired or wireless local area network (“LAN”) and a wide area network (“WAN”), an inter-network 1410 (e.g., the Internet), and peer-to-peer networks (e.g., ad hoc peer-to-peer networks).

The computing system can include any number of clients and servers. A client and server are generally remote from each other and typically interact through a communication network. The relationship of client and server arises by virtue of computer programs running on the respective computers and having a client-server relationship to each other. In some embodiments, a server 1450 transmits data (e.g., an HTML page) to a client device 1300 (e.g., for purposes of displaying data to and receiving user input from a user interacting with the client device). Data generated at the client device (e.g., a result of the user interaction) can be received from the client device at the server. In the embodiment shown in FIG. 13, the server computer 1450 operates server engine software 1460 and web management software 1470 to receive data from and send data to remote clients. In addition, the server computer operates a database 1490b to store persona information for users who wish to receive ads as described above. Content management software 1480 and database management software 1490 allow the server computer to store and retrieve persona information from the database and to search the database for personas that meet advertiser's criteria for a target audience.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/We claim:

1. A system comprising:
a. memory configured to store persona information about a plurality of users that indicates demographic characteristics and/or interests of a user and one or more contact addresses for a user; and
b. a processor configured to execute instructions that cause the processor to:
i. receive messages for a user at an address with a prefix that uniquely defines the user to a service or merchant and a common suffix to which messages to the system are addressed; and
ii. store in the memory a mapping of the addresses at which messages are received for the user to a contact address for the user.

2. The system of claim 1, wherein persona information is stored as an interest graph and wherein the demographic characteristics and/or interests are represented as interest graph nodes.

3. The system of claim 1, wherein the persona information is based at least on data from the arrangement of content detected on a client screen arranged by the user, wherein the content represents a number of brands to infer one or more demographic characteristics and/or interests of the user based on the detected arrangement of the content on the screen.

4. The system of claim 1, wherein the persona information represents a combination of demographic characteristics and/or interests that can be selected by the service or merchant to select a target audience.

5. The system of claim 1, wherein the address is an email address.

6. The system of claim 1, wherein the messages to the system from the service or merchant and the address are comprised of email addresses.

7. The system of claim 1, wherein the messages to the system from the service or merchant and the address are comprised of email addresses, wherein the email address shares a subdomain that is substantially identical to at least one the domain name of the service or merchant server that sent the messages to the system.

8. A computer system, comprising:
a. memory for storing instructions that are executable by processor electronics; and
a. processor electronics configured to execute the instructions in order to:
i. receive user login information from a user that is associated with a server that stores persona information about the user that is indicative of demographic characteristics and/or interests of the user; and
ii. receive information regarding a user's interest graph, wherein the instructions are executable by the processor to cause the processor to receive commands from the user.

9. The system of claim 8, wherein the commands comprise instructions to change an aspect of the interest graph.

10. The system of claim 9, further comprising instructions to transmit the changes to the server that stores the persona information.

11. The system of claim 8, wherein the commands are comprised of sharing particular demographic characteristics and/or interests of the user that the user selects.

12. The system of claim 8, further comprising instructions to forward the login information to a server that stores preexisting user login information.

13. The system of claim 12, further comprising receiving at least verification of the user's login identity from the server in response to the forwarding of the login information.

14. The system of claim 8, further comprising instructions to produce a user interface associated with a particular brand.

15. The system of claim 8, wherein the demographic characteristics and/or interests of the user are represented as nodes in an interest graph.

16. The system of claim 8, wherein the persona is based at least on data from the arrangement of content detected on a client screen arranged by the user, wherein the content represents a number of brands to infer one or more characteristics of the user based on the detected arrangement of the content on the screen.

17. The system of claim 8, wherein the persona represents a different combination of demographic characteristics and/or interests that can be selected by the service or merchant to select a target audience.

18. A computer system, comprising:
a. memory for storing instructions that are executable by processor electronics; and
b. processor electronics configured to execute the instructions in order to:
i. to produce a user interface associated with a particular brand;
ii. receive user login information from a user that is associated with a server that stores persona information about the user that is indicative of demographic characteristics and/or interests of the user;
iii. forward the information to a server that stores preexisting user login information; and
iv. receive information regarding a user's interest graph, wherein the instructions are executable by the processor to cause the processor to receive commands from the user.

19. The system of claim 18, wherein the commands comprise instructions to change an aspect of the interest graph.

20. The system of claim 18, wherein the persona is based at least on data from:
a. the arrangement of content detected on a client screen arranged by the user, wherein the content represents a number of brands to infer one or more characteristics of the user based on the detected arrangement of the content on the screen.
